(19) United States
(12) Patent Application Publication
(10) Pub. No.: US 2017/0109012 A1
(43) Pub. Date: Apr. 20, 2017

(54) SMART TV SET, AND METHOD FOR PROCESSING A THUMBNAIL OF A PICTURE

(71) Applicant: HISENSE ELECTRIC CO., LTD., Qingdao (CN)

(72) Inventor: Chunxiao CHEN, Qingdao (CN)

(21) Appl. No.: 15/391,075

(22) Filed: Dec. 27, 2016

(30) Foreign Application Priority Data
Nov. 7, 2016 (CN) 201610979256.0

(51) Int. Cl. G06F 3/0481; H04N 5/445; H04N 21/431; H04N 5/44; G06F 3/0483; G06F 3/0482

(52) U.S. Cl. CPC G06F 3/04817; G06F 3/0483; G06F 3/0482; H04N 21/4312; H04N 5/4403; H04N 5/44543

(57) ABSTRACT

The disclosure discloses a smart TV set, and a method for processing a thumbnail of a picture. The method includes: while pictures are being browsed, if a smart TV set determines that a focus on a screen has stayed on an icon of any one of the pictures for a period of time reaching a preset threshold, then acquiring and displaying a thumbnail of the picture corresponding to the icon where the focus is currently staying; and predicting, by the smart TV set, a next movement direction of the focus according to previous position changes of the focus, and acquiring and buffering thumbnails of a preset number of pictures in the next movement direction of the focus.

### CROSS-REFERENCE TO THE RELATED APPLICATION

This application claims the benefit and priority of Chinese Patent Application No. 201610979256.0 filed Nov. 7, 2016. The entire disclosure of the above application is incorporated herein by reference.

### FIELD

The present disclosure relates to the field of computers, and particularly to a smart TV set, and a method for processing a thumbnail of a picture.

### BACKGROUND

This section provides background information related to the present disclosure which is not necessarily prior art.

One of important functions of a smart TV set is to browse pictures, and since the size of a screen of the smart TV set is much larger than the size of a screen of a computer, a camera, a mobile phone, etc., the pictures can be browsed on the smart TV set for a better effect.

While a user is browsing the pictures, a thumbnail of a picture selected by the user frequently needs to be displayed. In the related technologies, the thumbnail of the picture is typically displayed by a view display control loading, decoding, and displaying the thumbnail in a primary thread. For example, in the Android system, the thumbnail is loaded, decoded, and displayed by the Grid View control or the List View control in the primary thread.

### SUMMARY

This section provides a general summary of the disclosure, and is not a comprehensive disclosure of its full scope or all of its features.

Embodiments of the disclosure provide a smart TV set, and a method for processing a thumbnail of a picture.

Some embodiments of the disclosure provide a smart TV set including: a memory and at least one processor, wherein the memory is configured to store computer readable program codes, and the at least one processor is configured to execute the computer readable program codes to perform:

while pictures are being browsed, if it is determined that a focus on a screen has stayed on an icon of any one of the pictures for a period of time reaching a preset threshold, acquiring and displaying a thumbnail of a picture corresponding to the icon where the focus is currently staying; and

predicting a next movement direction of the focus according to previous position changes of the focus, and acquiring and buffering thumbnails of a preset number of pictures in the next movement direction of the focus.

Some embodiments of the disclosure provide a method for processing a thumbnail of a picture, the method including:

while pictures are being browsed, if a smart TV set determines that a focus on a screen has stayed on an icon of any one of the pictures for a period of time reaching a preset threshold, then acquiring and displaying a thumbnail of a picture corresponding to the icon where the focus is currently staying; and

predicting, by the smart TV set, a next movement direction of the focus according to previous position changes of the focus, and acquiring and buffering thumbnails of a preset number of pictures in the next movement direction of the focus.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of a method for processing a thumbnail of a picture according to some embodiments of the disclosure;

FIG. 2 is a schematic diagram of another method for processing a thumbnail of a picture according to some embodiments of the disclosure;

FIG. 3 is a schematic diagram of a smart TV set according to some embodiments of the disclosure;

FIG. 4 is a schematic diagram of another smart TV set according to some embodiments of the disclosure; and

FIG. 5 is a schematic diagram of a further smart TV set according to some embodiments of the disclosure.

Corresponding reference numerals indicate corresponding parts or features throughout the several views of the drawings.

### DETAILED DESCRIPTION

Example embodiments will now be described more fully with reference to the accompanying drawings.

Some embodiments of the disclosure will be described below in further details. It shall be appreciated that the embodiments described here are merely intended to illustrate and describe the disclosure, but not to limit the disclosure.

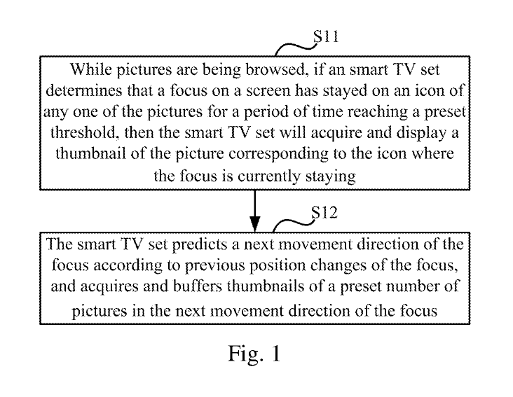

Some embodiments of the disclosure provide a method for processing a thumbnail of a picture, and referring to FIG. 1, the method includes the following operations:

S11, while pictures are being browsed, if a smart TV set determines that a focus on a screen has stayed on an icon of any one of the pictures for a period of time reaching a preset threshold, then the smart TV set will acquire and display a thumbnail of the picture corresponding to the icon where the focus is currently staying.

In some embodiments, it is determined whether a user has selected a picture displayed on the screen of the smart TV set, according to whether a focus on the screen has stayed on the icon of the picture for a period of time reaching the preset threshold, where the user controls the focus using direction keys (e.g., Upward, Downward, Leftward, Rightward, and Pg Up/Down) on a remote controller to stay on some picture to indicate that the user intends to know more information about the selected picture; and if the focus has stayed on the icon of any one picture displayed on the screen for a period of time reaching the preset threshold, then it will be determined that the user has selected the picture, and if the focus has stayed on the icon of the picture displayed on the screen for a period of time which does not reach the preset threshold, then it will be determined that the user has not selected the picture.

In some embodiments of the disclosure, the focus on the screen of the smart TV set can be presented in the form of a cursor, can be highlighted, etc., but the embodiments of the disclosure will not be limited to any particular implementation of the focus. In some embodiments of the disclosure, the preset threshold can be preset empirically, as a result of simulation, or as required for human-machine interaction. For example, the preset threshold is preset to 1.5 seconds or 2 seconds.

S12, the smart TV set predicts a next movement direction of the focus according to previous position changes of the focus, and acquires and buffers thumbnails of a preset number of pictures in the next movement direction of the focus.

In some embodiments, after the thumbnail of the picture corresponding to the icon currently selected by the user is displayed, the smart TV set predicts pictures likely to be next selected by the user, according to the latest operation by the user to control the focus, and acquires and buffers thumbnails of the predicted pictures without displaying them.

In some embodiments of the disclosure, the movement direction of the focus includes but will not be limited to upward movement, downward movement, leftward movement, rightward movement, or page turning movement of the focus on the screen.

In some embodiments of the disclosure, while the pictures are being browsed, if the smart TV set determines that the focus on the screen has stayed on the icon of any one picture for a period of time reaching the preset threshold, then the smart TV set will acquire and display the thumbnail of the picture corresponding to the icon where the focus is currently staying; and predict the next movement direction of the focus according to the previous position changes of the focus, and acquire and buffer the thumbnails of a preset number of pictures in the next movement direction of the focus, that is, determine the pictures likely to be next selected, according to the predicted next movement direction of the focus, decode the pictures likely to be next selected, acquire the thumbnails of these pictures, and generate a temporary file, so that if the focus next moves to and has stayed on the icon of one of the pictures for which the thumbnails have been buffered, for a period of time reaching the preset threshold, then the thumbnail will be retrieved and displayed directly from the temporary file to thereby shorten a period of time for loading the thumbnail, and improve the speed at which the thumbnail of the picture is displayed, so as to improve the experience of the user; and since not all the thumbnails of the pictures are buffered in advance, few system resources will be occupied. With the solution according to the embodiments of the disclosure, the thumbnail of the picture selected by the user can be displayed more quickly while consuming the system resources as few as possible; and due to the operational continuity of the user, the next operation can be predicted from the known movement behavior of the focus, and the thumbnail to be displayed can be acquired in advance, thus greatly improving the usability of the smart TV set, and the experience of the user.

In the related technologies, after a USB device accesses the smart TV set, a software system starts a function to scan files by scanning the respective files in the USB device one by one, and buffering thumbnails of the respective pictures, and since the files have to be scanned by occupying a lot of resources in the system, thus degrading the response speed to a button being pressed in the system, the speed at which the pictures are played, etc., the pictures may not be browsed until their thumbnails are buffered in a file. With the solution according to some embodiments of the disclosure, if the focus on the screen of the smart TV set has stayed on the icon of some picture for a period of time reaching the preset threshold, then the thumbnail of the picture will be acquired and displayed, the pictures likely to be next selected will be predicted, the thumbnails of the predicted pictures will be acquired, and the temporary file will be generated from the thumbnails. Since the thumbnails of the respective pictures in the USB devices need not be scanned and buffered one by one, few system resources will be occupied; and due to the operational continuity of the user, the pictures likely to be next selected can be predicted, and their thumbnails can be buffered, thus greatly improving the usability of the smart TV set, and the experience of the user.

In some embodiments of the disclosure, if the position of the focus is changed while the operation S12 is being performed, then the operation S12 will be stopped from being performed, and the operations S11 and S12 will be performed again after the position of the focus is determined.

The smart TV set can predict the next movement direction of the focus according to the previous position changes of the focus in the operation S12 in the following two implementations:

In a first implementation, the smart TV set determines a last movement direction of the focus as the next movement direction of the focus according to the previous position changes of the focus.

In this implementation, a next operational behavior of the user is predicted according to a latest operational behavior of the user. For example, if the latest operational behavior of the user is to move the focus downward, that is, the focus moves downward, then the next operational behavior of the user will be predicted also as moving the focus downward, that is, the next movement direction of the focus will be predicted as downward movement.

In a second implementation, the smart TV set determines such one of the latest N movement directions of the focus that has the largest count as the next movement direction of the focus according to the previous position changes of the focus.

In this implementation, a next operational behavior of the user is predicted according to the latest N latest operational behaviors of the user in such a way that such one of the latest N operational behaviors that has occurred for the largest number of times is predicted as the next operational behavior of the user, that is, such one of the latest N movement directions of the focus that has the largest count is determined as the next movement direction of the focus.

For example, 10 latest operational behaviors of the user are counted, and if there are 2 downward operations, 5 page turning operations, and 3 upward operations, where the page turning operation has occurred for the largest number of times, then the next operational behavior of the user will be predicted as the page turning operation.

Further to any one of the embodiments above, the smart TV set can acquire and buffer the thumbnails of the preset number of pictures in the predicted movement direction in the following several possible scenarios:

In a first scenario, if the next movement direction of the focus is predicted as page turning movement, then the smart TV set will acquire and buffer thumbnails of pictures, corresponding to icons at the same position as the icon where the focus is currently staying, in a preset number of pages following the current page.

By way of an example, if the pictures are arranged on the screen in the form of a list, then if the icon where the focus is currently staying is the second icon in the list, and the next movement direction of the focus is predicted as page turning movement, then thumbnails of pictures corresponding to icons arranged at the second places in a preset number of pages following the current page will be acquired and buffered. For example, if the preset number is 5, then thumbnails of pictures corresponding to icons arranged at the second places in the first to fifth pages following the current page will be acquired and buffered. If the pictures are arranged on the screen in the form of an array, then if the icon where the focus is currently staying is the icon in the second row and in the second column, and the next movement direction of the focus is predicted as page turning movement, then thumbnails of pictures corresponding to icons arranged in the second rows and the second columns in a preset number of pages following the current page will be acquired and buffered.

In a second scenario, if the next movement direction of the focus is predicted as upward movement, then the following description will be given respectively in an example where the pictures are arranged on the screen in the form of a list, and an example where the pictures are arranged on the screen in the form of an array, but it shall be appreciated that the form in which the pictures are arranged on the screen will not be limited to the following two arrangement forms:

1. If the pictures are arranged on the screen in the form of a list, and the next movement direction of the focus is predicted as upward movement, then the smart TV set will acquire and buffer thumbnails of a preset number of pictures above the icon where the focus is currently staying. For example, if the preset number is 3, there are icons of 10 pictures in total displayed on the screen, and the user moves upward the focus to select the fourth icon (i.e., the icon at the position numbered 4), then after the thumbnail of the picture corresponding to the fourth icon is acquired and displayed, the thumbnails of the icons corresponding to the third, second, and first icons will be acquired and buffered in sequence, but not displayed.

If the pictures are arrayed on the screen in the form of a list, if the preset number is more than M, where M is the serial number of the position of the icon where the focus is currently staying minus 1, that is, the number of icons in the current page with the serial numbers of their positions being decremented from the position of the icon where the focus is currently staying is less than the preset number, then thumbnails of pictures corresponding to P icons decremented from the last position in the previous page will be acquired and buffered, where P is the preset number minus M. By way of an example, if the preset number is 3, there are 10 icons in total from the top to the bottom per page, and the icon where the focus is currently staying is the second icon, then the thumbnail of the picture corresponding to the first icon in the current page will be acquired and buffered, and the thumbnails of the pictures corresponding to the tenth and ninth icons in the previous page will be acquired and buffered.

2. If the pictures are arranged on the screen in the form of an array, and the next movement direction of the focus is predicted as upward movement, then the smart TV set will acquire and buffer thumbnails of a preset number of pictures in the same column as the icon where the focus is currently staying, and in rows with their serial numbers being decremented from the row including the icon where the focus is currently staying.

For example, if the preset number is 3, and the icon where the focus is currently staying is the icon in the fifth row and in the second column, then the thumbnails of the pictures corresponding to the icons in the fourth row and in the second column, in the third row and in the second column, and in the second row and in the second column will be acquired and buffered.

If the pictures are arranged on the screen in the form of an array, then if the preset number is more than M, where M is the serial number of the row including the icon where the focus is currently staying minus 1, that is, the number of icons in the same column as the icon where the focus is currently staying, and in the rows with their serial numbers being decremented from the row including the icon where the focus is currently staying in the current page is less than the preset number, then thumbnails of pictures corresponding to P icons in the same column as the icon where the focus is currently staying, and in rows decremented from the last row in the previous page will be acquired and buffered, where P is the preset number minus M. By way of an example, if the preset number is 3, there are icons in 10 rows and in 10 columns per page, and the icon where the focus is currently staying is the icon in the second row and in the second column, then the thumbnail of the picture corresponding to the icon in the first row and in the second column in the current page, and the thumbnails of the pictures corresponding to the icons in the tenth row and in the second column, and in the ninth row and in the second column in the previous page will be acquired and buffered.

In a third scenario, if the next movement direction of the focus is predicted as downward movement, then the following description will be given respectively in an example where the pictures are arranged on the screen in the form of a list, and an example where the pictures are arranged on the screen in the form of an array, but it shall be appreciated that the form in which the pictures are arranged on the screen will not be limited to the following two arrangement forms:

1. If the pictures are arranged on the screen in the form of a list, and the next movement direction of the focus is predicted as downward movement, then the smart TV set will acquire and buffer thumbnails of a preset number of pictures below the icon where the focus is currently staying.

If the pictures are arrayed on the screen in the form of a list, if the preset number is more than M, where M is the total number of icons per page minus the serial number of the position of the icon where the focus is currently staying, that is, the number of icons in the current page with the serial numbers of their positions being incremented from the position of the icon where the focus is currently staying is less than the preset number, then thumbnails of pictures corresponding to P icons incremented from the first position in the next page will be acquired and buffered, where P is the preset number minus M. By way of an example, if the preset number is 3, there are 10 icons in total from the top to the bottom per page, and the icon where the focus is currently staying is the ninth icon, then the thumbnail of the picture corresponding to the tenth icon in the current page will be acquired and buffered, and the thumbnails of the pictures corresponding to the first and second icons in the next page will be acquired and buffered.

2. If the pictures are arranged on the screen in the form of an array, and the next movement direction of the focus is predicted as downward movement, then the smart TV set will acquire and buffer thumbnails of a preset number of pictures in the same column as the icon where the focus is currently staying, and in rows with their serial numbers being incremented from the row including the icon where the focus is currently staying.

For example, if the preset number is 3, there are icons in 10 rows and in 10 columns per page, and the icon where the focus is currently staying is the icon in the fifth row and in the second column, then the thumbnails of the pictures corresponding to the icons in the sixth row and in the second column, in the seventh row and in the second column, and in the eighth row and in the second column will be acquired and buffered.

If the pictures are arranged on the screen in the form of an array, then if the preset number is more than M, where M is the total number of rows of icons in the current page minus the serial number of the row including the icon where the focus is currently staying, that is, the number of icons in the same column as the icon where the focus is currently staying, and in the rows with their serial numbers being incremented from the row including the icon where the focus is currently staying in the current page is less than the preset number, then thumbnails of pictures corresponding to P icons in the same column as the icon where the focus is currently staying, and in rows incremented from the first row in the next page will be acquired and buffered, where P is the preset number minus M. By way of an example, if the preset number is 3, there are icons in 10 rows and in 10 columns per page, and the icon where the focus is currently staying is the icon in the ninth row and in the second column, then the thumbnail of the picture corresponding to the icon in the tenth row and in the second column in the current page, and the thumbnails of the pictures corresponding to the icons in the first row and in the second column, and in the second row and in the second column in the next page will be acquired and buffered.

In a fourth scenario, if the pictures are arranged on the screen in the form of an array, and the next movement direction of the focus is predicted as leftward movement, then:

The smart TV set will acquire and buffer thumbnails of a preset number of pictures in the same row as the icon where the focus is currently staying, and in columns with their serial numbers being decremented from the column including the icon where the focus is currently staying.

For example, if the preset number is 3, there are icons in 10 rows and in 10 columns per page, and the icon where the focus is currently staying is the icon in the fifth row and in the seventh column, then the thumbnails of the pictures corresponding to the icons in the fifth row and in the sixth column, in the fifth row and in the fifth column, and in the fifth row and in the fourth column will be acquired and buffered.

If the preset number is more than M, where M is the serial number of the column including the icon where the focus is currently staying, that is, the number of icons in the same row as the icon where the focus is currently staying, and in columns with their serial numbers being decremented from the column including the icon where the focus is currently staying in the current page is less than the preset number, then thumbnails of pictures corresponding to P icons in the same row as the icon where the focus is currently staying, and in columns decremented from the last column in the previous page will be acquired and buffered, where P is the preset number minus M. By way of an example, if the preset number is 3, there are icons in 10 rows and in 10 columns per page, and the icon where the focus is currently staying is the icon in the ninth row and in the second column, then the thumbnail of the picture corresponding to the icon in the ninth row and in the first column in the previous page, and the thumbnails of the pictures corresponding to the icons in the ninth row and the tenth column, and in the ninth row and the ninth column in the previous page will be acquired and buffered.

In a fifth scenario, if the pictures are arranged on the screen in the form of an array, and the next movement direction of the focus is predicted as rightward movement, then:

The smart TV set will acquire and buffer thumbnails of a preset number of pictures in the same row as the icon where the focus is currently staying, and in columns with their serial numbers being incremented from the column including the icon where the focus is currently staying.

For example, if the preset number is 3, there are icons in 10 rows and in 10 columns per page, and the icon where the focus is currently staying is the icon in the fifth row and in the second column, then the thumbnails of the pictures corresponding to the icons in the fifth row and in the third column, in the fifth row and in the fourth column, and in the fifth row and in the fifth column will be acquired and buffered.

If the preset number is more than M, where M is the total number of columns of icons in the current page minus the serial number of the column including the icon where the focus is currently staying, that is, the number of icons in the same row as the icon where the focus is currently staying, and in columns with their serial numbers being incremented from the column including the icon where the focus is currently staying in the current page is less than the preset number, then thumbnails of pictures corresponding to P icons in the same row as the icon where the focus is currently staying, and in columns incremented from the first column in the next page will be acquired and buffered, where P is the preset number minus M. By way of an example, if the preset number is 3, there are icons in 10 rows and in 10 columns per page, and the icon where the focus is currently staying is the icon in the ninth row and in the ninth column, then the thumbnail of the picture corresponding to the icon in the ninth row and in the tenth column in the current page, and the thumbnails of the pictures corresponding to the icons in the ninth row and the first column, and in the ninth row and the second column in the next page will be acquired and buffered.

Further to any one of the embodiments above, the smart TV set can acquire and buffer the thumbnails of the preset number of pictures in the predicted movement direction in the operation S12 as follows:

The smart TV set acquires and buffers the thumbnails of the preset number of pictures in the predicted movement direction in a multi-thread mode.

The thumbnails of a plurality of predicted pictures can be acquired and buffered concurrently in the multi-thread mode to thereby speed up retrieval of the thumbnails of the predicted pictures.

Further to any one of the embodiments above, the operations in the operations S11 and S12, and the operation of moving the focus can be performed in an asynchronous mode, that is, the operations in the operations S11 and S12 can be performed by creating a new thread to thereby avoid a primary thread, in which a User Interface (UI) resides, from being blocked so as to alleviate an effect on the response of the operations by the user and the operation on the UI.

A method for processing a thumbnail of a picture according to some embodiments of the disclosure will be described below in details taking a smart TV set as an example.

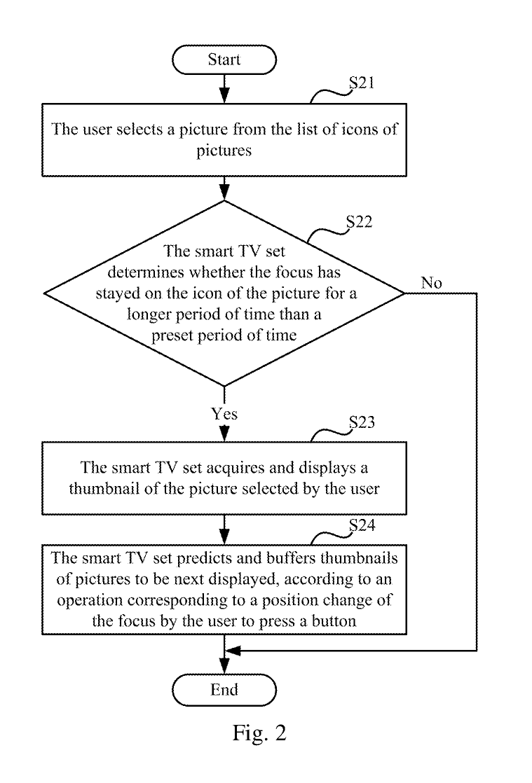

In some embodiments of the disclosure, a user moves a focus on a menu, in a list of icons of pictures to select one of the pictures. If the picture is selected, and the focus has stayed for a longer period of time than a preset period of time (e.g., 1.5 seconds), then the smart TV set will create a new thread asynchronously to acquire a thumbnail of the selected picture, and store the acquired thumbnail in a temporary file; and display the thumbnail, predict a next picture according to an operation corresponding to a position change of the focus by the user to press a button (e.g., the lastly accessed button or the most frequently accessed button), where the button can be a direction key (e.g., Upward, Downward, Leftward, Rightward, or Pg Up/Down) on the remote controller, calculate a storage directory of the next picture according to information in the list of file, and generate and store a thumbnail file, particularly as illustrated in FIG. 2, where the method includes the following operations:

In the operation S21, the user selects a picture from the list of icons of pictures;

In some embodiments of the disclosure, the user can control the focus on the screen of the smart TV set to select the picture from the list of icons of the pictures displayed on the screen; and if the user controls the focus to stay on the icon of the picture, then the icon will be highlighted.

In the operation S22, the smart TV set determines whether the focus has stayed on the icon of the picture for a longer period of time than a preset period of time; and

If so, then the flow will proceed to the operation S23;

Otherwise, the flow will end.

In the operation S23, the smart TV set acquires and displays a thumbnail of the picture selected by the user.

In the operation S24, the smart TV set predicts and buffers thumbnails of pictures to be next displayed, according to an operation corresponding to a position change of the focus by the user to press a button.

The processing flow of the method above can be performed in software program which can be stored in a storage medium, where the stored software program is invoked to perform the operations of the method above.

Based upon the same inventive idea, some embodiments of the disclosure further provides a smart TV set, and since the smart TV set addresses the problem under a similar principle to the method according to some embodiments illustrated in FIG. 1, reference can be made to the implementation of the method for an implementation of the smart TV set, so a repeated description thereof will be omitted here.

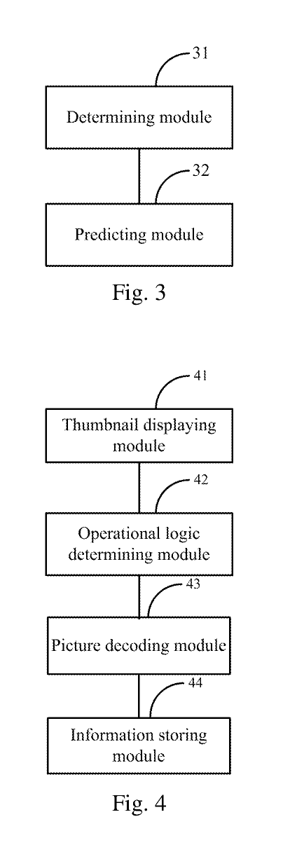

Some embodiments of the disclosure provide a smart TV set as illustrated in FIG. 3 including:

A determining module 31 is configured, while pictures are being browsed, if it is determined that a focus on a screen has stayed on an icon of any one of the pictures for a period of time reaching a preset threshold, to acquire and display a thumbnail of the picture corresponding to the icon where the focus is currently staying; and

A predicting module 32 is configured to predict a next movement direction of the focus according to previous position changes of the focus, and to acquire and buffer thumbnails of a preset number of pictures in the next movement direction of the focus.

In some embodiments of the disclosure, the predicting module 32 is particularly configured:

To determine a last movement direction of the focus as the next movement direction of the focus according to the previous position changes of the focus; or

To determine such one of the latest N movement directions of the focus that has the largest count as the next movement direction of the focus according to the previous position changes of the focus.

In some embodiments of the disclosure, the movement direction of the focus includes:

Upward movement, downward movement, leftward movement, rightward movement, or page turning movement of the focus on the screen.

In some embodiments of the disclosure, the predicting module 32 is particularly configured:

If the next movement direction of the focus is predicted as page turning movement, to acquire and buffer thumbnails of pictures, corresponding to icons at the same position as the icon where the focus is currently staying, in a preset number of pages following the current page.

In some embodiments of the disclosure, the predicting module 32 is particularly configured:

To acquire and buffer the thumbnails of the preset number of pictures in the predicted movement direction in a multi-thread mode.

Some embodiments of the disclosure provide another smart TV set as illustrated in FIG. 4 including:

A thumbnail displaying module 41 is configured to display a thumbnail of a picture currently selected by a user;

An operational logic determining module 42 is configured to determine and acquire pictures to be next displayed, according to an operation corresponding to a position change of the focus by the user to press a button (e.g., the lastly accessed button or the most frequently accessed button);

A picture decoding module 43 is configured to decode the acquired pictures, to acquire their thumbnails, and to generate a temporary file from the thumbnails; and

An information storing module 44 is configured to store the generated temporary file of the thumbnails, and to record file information of a list of pictures;

Here the temporary file stored by the information storing module 44 includes the thumbnail of the picture currently selected by the user, and the thumbnails of the predicted pictures to be next displayed.

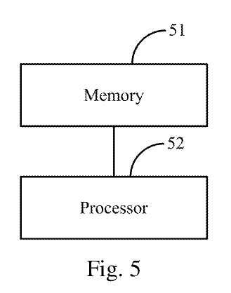

Some embodiments of the disclosure provide another smart TV set as illustrated in FIG. 5 including:

A memory 51 and at least one processor 52, where one processor is illustrated in FIG. 5 by way of an example; and the memory 51 is configured to store computer readable program codes, and the processor 52 is configured to execute the computer readable program codes to perform:

While pictures are being browsed, if it is determined that a focus on a screen has stayed on an icon of any one of the pictures for a period of time reaching a preset threshold, acquiring and displaying a thumbnail of the picture corresponding to the icon where the focus is currently staying; and

Predicting a next movement direction of the focus according to previous position changes of the focus, and acquiring and buffering thumbnails of a preset number of pictures in the next movement direction of the focus.

In some embodiments of the disclosure, the processor 52 is further configured to execute the computer readable program codes to perform:

Determining a last movement direction of the focus as the next movement direction of the focus according to the previous position changes of the focus; or

Determining such one of the latest N movement directions of the focus that has the largest count as the next movement direction of the focus according to the previous position changes of the focus.

In some embodiments of the disclosure, the movement direction of the focus includes:

Upward movement, downward movement, leftward movement, rightward movement, or page turning movement of the focus on the screen.

In some embodiments of the disclosure, the processor 52 is further configured to execute the computer readable program codes to perform:

If the next movement direction of the focus is predicted as page turning movement, acquiring and buffering thumbnails of pictures, corresponding to icons at the same position as the icon where the focus is currently staying, in a preset number of pages following the current page.

In some embodiments of the disclosure, the processor 52 is further configured to execute the computer readable program codes to perform:

Acquiring and buffering the thumbnails of the preset number of pictures in the predicted movement direction in a multi-thread mode.

Those skilled in the art shall appreciate that the embodiments of the disclosure can be embodied as a method, a system or a computer program product. Therefore the disclosure can be embodied in the form of an all-hardware embodiment, an all-software embodiment or an embodiment of software and hardware in combination. Furthermore the disclosure can be embodied in the form of a computer program product embodied in one or more computer useable storage mediums (including but not limited to a disk memory, a CD-ROM, an optical memory, etc.) in which computer useable program codes are contained.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational operations are performed on the computer or the other programmable data processing device to create a computer implemented process so that the instructions executed on the computer or the other programmable device provide operations for performing the functions specified in the flow(s) of the flow chart and/or the block(s) of the block diagram.

Although the preferred embodiments of the disclosure have been described, those skilled in the art benefiting from the underlying inventive concept can make additional modifications and variations to these embodiments. Therefore the appended claims are intended to be construed as encompassing the preferred embodiments and all the modifications and variations coming into the scope of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A smart TV set, comprising: a memory and at least one processor, wherein the memory is configured to store computer readable program codes, and the at least one processor is configured to execute the computer readable program codes to perform:
while pictures are being browsed, if it is determined that a focus on a screen has stayed on an icon of any one of the pictures for a period of time reaching a preset threshold, acquiring and displaying a thumbnail of a picture corresponding to the icon where the focus is currently staying; and
predicting a next movement direction of the focus according to previous position changes of the focus, and acquiring and buffering thumbnails of a preset number of pictures in the next movement direction of the focus.

2. The smart TV set according to claim 1, wherein the at least one processor is further configured to execute the computer readable program codes to perform:
determining a last movement direction of the focus as the next movement direction of the focus according to the previous position changes of the focus; or
determining such one of latest N movement directions of the focus that has a largest count as the next movement direction of the focus according to the previous position changes of the focus.

3. The smart TV set according to claim 1, wherein the movement direction of the focus comprises:
upward movement, downward movement, leftward movement, rightward movement, or page turning movement of the focus on the screen.

4. The smart TV set according to claim 2, wherein the movement direction of the focus comprises:
upward movement, downward movement, leftward movement, rightward movement, or page turning movement of the focus on the screen.

5. The smart TV set according to claim 3, wherein the at least one processor is further configured to execute the computer readable program codes to perform:
if the next movement direction of the focus is predicted as page turning movement, acquiring and buffering thumbnails of pictures, corresponding to icons at a same position as the icon where the focus is currently staying, in a preset number of pages following the current page.

6. The smart TV set according to claim 4, wherein the at least one processor is further configured to execute the computer readable program codes to perform:
if the next movement direction of the focus is predicted as page turning movement, acquiring and buffering thumbnails of pictures, corresponding to icons at a same position as the icon where the focus is currently staying, in a preset number of pages following the current page.

7. The smart TV set according to claim 1, wherein the at least one processor is further configured to execute the computer readable program codes to perform:
acquiring and buffering the thumbnails of the preset number of pictures in the predicted movement direction in a multi-thread mode.

8. A method for processing a thumbnail of a picture, the method comprising:
while pictures are being browsed, if a smart TV set determines that a focus on a screen has stayed on an icon of any one of the pictures for a period of time reaching a preset threshold, then acquiring and displaying a thumbnail of a picture corresponding to the icon where the focus is currently staying; and
predicting, by the smart TV set, a next movement direction of the focus according to previous position changes of the focus, and acquiring and buffering thumbnails of a preset number of pictures in the next movement direction of the focus.

9. The method according to claim 8, wherein predicting, by the smart TV set, the next movement direction of the focus according to the previous position changes of the focus comprises:
determining, by the smart TV set, a last movement direction of the focus as the next movement direction of the focus according to the previous position changes of the focus; or
determining, by the smart TV set, such one of latest N movement directions of the focus that has a largest count as the next movement direction of the focus according to the previous position changes of the focus.

10. The method according to claim 8, wherein the movement direction of the focus comprises:
upward movement, downward movement, leftward movement, rightward movement, or page turning movement of the focus on the screen.

11. The method according to claim 9, wherein the movement direction of the focus comprises:
upward movement, downward movement, leftward movement, rightward movement, or page turning movement of the focus on the screen.

12. The method according to claim 10, wherein acquiring and buffering, by the smart TV set, the thumbnails of the preset number of pictures in the predicted movement direction comprises:
if the next movement direction of the focus is predicted as page turning movement, then acquiring and buffering, by the smart TV set, thumbnails of pictures, corresponding to icons at a same position as the icon where the focus is currently staying, in a preset number of pages following the current page.

13. The method according to claim 11, wherein acquiring and buffering, by the smart TV set, the thumbnails of the preset number of pictures in the predicted movement direction comprises:
if the next movement direction of the focus is predicted as page turning movement, then acquiring and buffering, by the smart TV set, thumbnails of pictures, corresponding to icons at a same position as the icon where the focus is currently staying, in a preset number of pages following the current page.

14. The method according to claim 8, wherein acquiring and buffering, by the smart TV set, the thumbnails of the preset number of pictures in the predicted movement direction comprises:
acquiring and buffering, by the smart TV set, the thumbnails of the preset number of pictures in the predicted movement direction in a multi-thread mode.
